(19) United States
(12) Patent Application Publication
(10) Pub. No.: US 2017/0000190 A1
(43) Pub. Date: Jan. 5, 2017

(54) ELECTRONIC CIGARETTE DEVICE

(71) Applicant: SHENZHEN SMACO TECHNOLOGY LIMITED, Shenzhen City (CN)

(72) Inventor: YANGYANG WU, Shenzhen City (CN)

(21) Appl. No.: 14/788,784

(22) Filed: Jun. 30, 2015

(51) Int. Cl. A24F 47/00; H05B 1/02

(52) U.S. Cl. CPC A24F 47/008; H05B 1/0244

(57) ABSTRACT

The present invention discloses an electronic cigarette device comprising an outer tube, a heating atomizing component accommodated in the outer tube, a PCB component disposed at a bottom of the heating atomizing component and a battery electrically connecting to the PCB component. The heating atomizing component comprises a heating element, a connector electrically connecting to a bottom of the heating element, and an atomizing tube sheathedly installed outside the heating element and the connector. A top of the atomizing tube is provided and disposed with a liquid filling cover and a detachable inhaling beak. A printed circuit board is disposed at a bottom of the connector. An electrode contact used for electrically connecting to the printed circuit board is disposed at a top of the PCB component. A plurality of air inlet micro holes are installed and disposed on the printed circuit board.

### BACKGROUND OF THE INVENTION

1. Field of the Invention

The present invention relates to electronic cigarette technology fields, and especially to an electronic cigarette device.

2. The Related Arts

Electronic cigarettes, also known as virtual cigarettes or electronic atomizers, are mainly used for smoke quitting and substituting actual cigarettes. Electronic cigarettes have a same appearance as and similar taste to actual cigarettes. Some electronic cigarettes even have more tastes than general actual cigarettes. Electronic cigarettes can be used to suck out smoke and flavors therein, and to sense feelings of inhaling and exhaling same as actual cigarettes. In addition, electronic cigarettes have no other harmful ingredients existing in actual cigarettes, such as tar and suspended particles, etc. Hence, electronic cigarettes have become the best alternatives to replace actual cigarettes.

An atomizer of an existing electronic cigarette generally only has one vent hole connecting to the outside world mostly. The vent hole has a larger diameter, and as a result, it not only makes a noise like whistling when users smoke, but also requires extreme suction forces and leads to a feeling of struggling for users to smoke. Besides, the atomizer and a battery of the existing electronic cigarette are mostly threadedly connected. Such connection manner causes rigmarole operation, a higher manufacturing cost and hard engaging which results in non-conducting under a condition that an error occurs.

### SUMMARY OF THE INVENTION

The main objective of the present invention is to provide an electronic cigarette device which is quiet, noiseless, and smooth to take in air. The electronic cigarette device of the present invention is able to overcome existing problems of loud noises and required extreme suction forces. Additionally, the electronic cigarette device of the present invention is easy to use and operate.

To achieve the above mentioned objectives of the present invention, the present invention adopts technology solutions as follows.

An electronic cigarette device in accordance with the present invention comprises an outer tube, a heating atomizing component accommodated in the outer tube, a printed circuit board (PCB) component disposed at a bottom of the heating atomizing component and a battery electrically connecting to the PCB component. The heating atomizing component comprises a heating element, a connector electrically connecting to a bottom of the heating element, and an atomizing tube sheathedly installed outside the heating element and the connector. A top of the atomizing tube is provided and disposed with a liquid filling cover and a detachable inhaling beak. A printed circuit board is disposed at a bottom of the connector. An electrode contact is disposed at a top of the PCB component and is used for electrically connecting to the printed circuit board. A plurality of air inlet micro holes are installed and disposed on the printed circuit board.

Furthermore, in the electronic cigarette device as described above, a liquid storage used for storing tobacco liquid is formed between the atomizing tube and the heating element. The heating atomizing component further comprises a liquid guiding twine used for delivering tobacco liquid to the heating element. The liquid guiding twine is located and disposed within the liquid storage.

Furthermore, in the electronic cigarette device as described above, a magnet attaches to the bottom of the connector.

Furthermore, in the electronic cigarette device as described above, the atomizing tube is made of transparent materials. An elongated through hole is disposed a location of the outer tube corresponding to the atomizing tube.

Furthermore, in the electronic cigarette device as described above, a Universal Serial Bus (USB) port used for charging the battery is disposed at a bottom of the outer tube.

Furthermore, in the electronic cigarette device as described above, the electrode contact is an elastic electrode contact. A copper foil used for electrically conducting is provided and disposed on the printed circuit board.

Furthermore, in the electronic cigarette device as described above, the liquid filling cover is located at the top of the atomizing tube. A liquid filling hole and an exhaust hole are respectively disposed and installed at the liquid filling cover.

Furthermore, in the electronic cigarette device as described above, a switch button is provided and disposed on the PCB component. A hole is disposed at a location of the outer tube corresponding to the switch button.

The electronic cigarette device of the present invention utilizes the plurality of air inlet micro holes installed and disposed on the printed circuit board disposed at the bottom of the connector to make the electronic cigarette device working silently and noiselessly. Airflow fills into the heating atomizing component automatically so that the purpose of smoking smoothly and relaxingly for users can be achieved. The electronic cigarette device of the present invention uses the elastic electrode contact to connect the battery with the heating atomizing component. It has advantages of being easy to operate and high reliability.

### BRIEF DESCRIPTION OF THE DRAWINGS

FIG. 1 is a structural schematic exploded perspective view of an electronic cigarette device in accordance with an embodiment of the present invention.

FIG. 2 is a schematic cross sectional view of the electronic cigarette device as shown in FIG. 1 in accordance with the present invention.

FIG. 3 is a schematic cross sectional view of the electronic cigarette device as shown in FIG. 1 viewed from another viewing angle in accordance with the present invention.

FIG. 4 is a structural schematic perspective view of a connector shown in FIG. 1.

FIG. 5 is a structural schematic perspective view of a liquid filling plug shown in FIG. 1.

### DETAILED DESCRIPTION OF PREFERRED EMBODIMENT

In order to facilitate understanding of the present invention, the following descriptions accompanying attached drawings are presented to further completely describe the present invention. Attached drawings show a preferred embodiment of the present invention. However, the present invention may be implemented by many different forms thereof and is not limited to the preferred embodiments described herein. On the contrary, the purpose of providing these embodiments is for much more thorough and entire understanding of the published disclosure of the present invention.

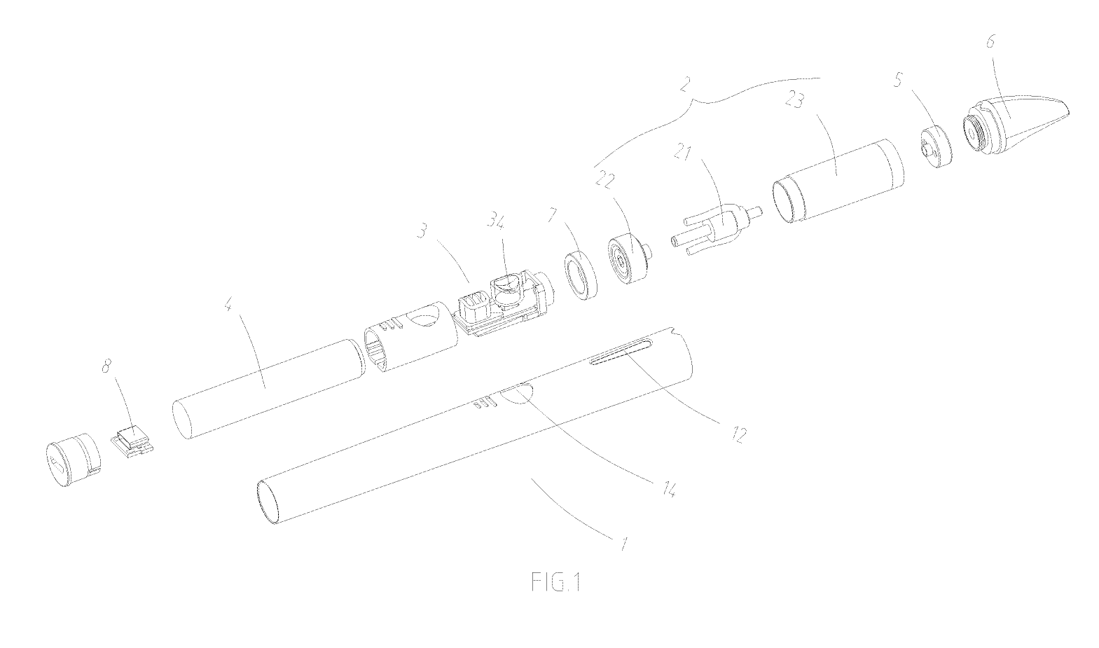

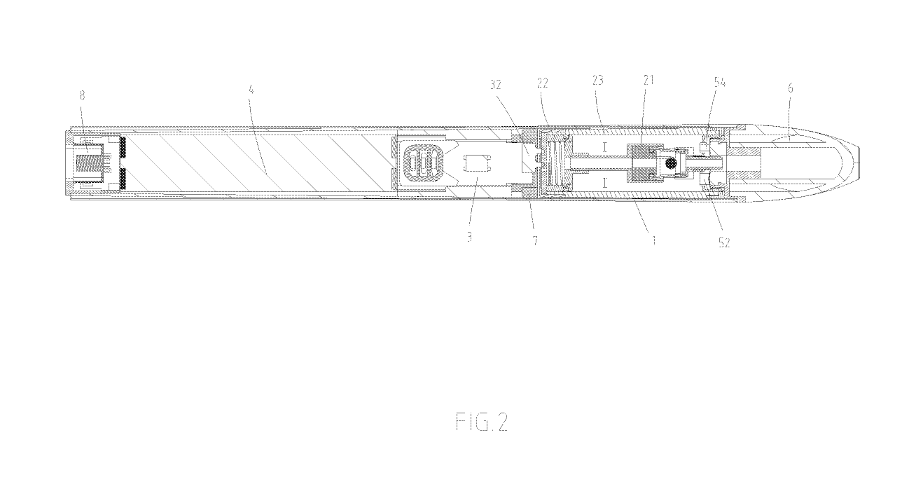

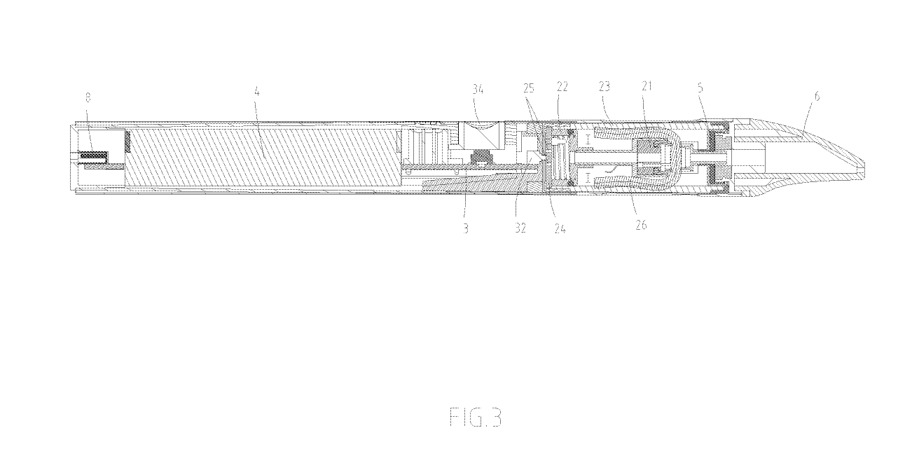

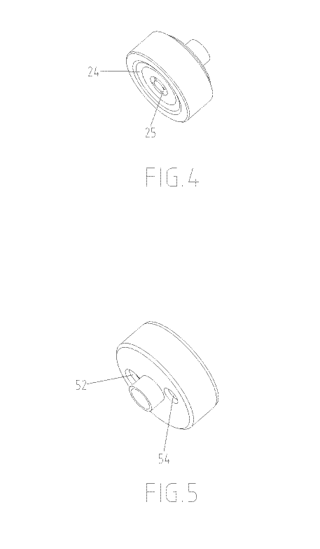

Referring to FIGS. 1 to 5, an electronic cigarette device in accordance with the present invention comprises an outer tube 1, a heating atomizing component 2 accommodated in the outer tube 1, a printed circuit board (PCB) component 3 disposed at a bottom of the heating atomizing component 2 and a battery 4 electrically connecting to the PCB component 3. The heating atomizing component 2 comprises a heating element 21, a connector 22 electrically connecting to a bottom of the heating element 21, and an atomizing tube 23 sheathedly installed outside the heating element 21 and the connector 22. A top of the atomizing tube 23 is provided and disposed with a liquid filling cover 5 and a detachable inhaling beak 6. A printed circuit board 24 is disposed at a bottom of the connector 22. An electrode contact 32 is disposed at a top of the PCB component 3 and is used for electrically connecting to the printed circuit board 24. A plurality of air inlet micro holes 25 are installed and disposed on the printed circuit board 24.

Herein, a liquid storage I used for storing tobacco liquid is formed between the atomizing tube 23 and the heating element 21. The heating atomizing component 2 further comprises a liquid guiding twine 26 used for delivering tobacco liquid to the heating element 21. The liquid guiding twine 26 is located and disposed within the liquid storage I.

The liquid filling cover 5 is located at the top of the atomizing tube 23. A liquid filling hole 52 and an exhaust hole 54 are respectively disposed and installed at the liquid filling cover 5. When refilling tobacco liquid, tobacco liquid is poured through the liquid filling hole 52 and air can be exhausted smoothly from the exhaust hole 54 during pouring tobacco liquid.

A magnet 7 attaching to the bottom of the connector 22 is used for fixing the heating element 21 and the connector 22.

The electrode contact 32 is an elastic electrode contact (i.e., retractable). A copper foil (not shown) used for electrically conducting is provided and disposed on the printed circuit board 24. The PCB component 3 is electrically connected to the printed circuit board 24 through contacting between the electrode contact 32 and the copper foil. When the electrode contact 32 makes contact and connection with the printed circuit board 24, since an air passage exists between the connector 22 and a top of the PCB component 3, the connector 22 is electrically connected to the heating element 21 and the heating element 21 generates heat after electrically conducting with the PCB component 3.

The inhaling beak 6 is spatially communicated with the heating element 21 and the connector 22 along an axial direction of the electronic cigarette device. Air enters the connector 22 through the air inlet micro holes 25 installed and disposed on the printed circuit board 24, and is mixed with heated tobacco liquid by the heating element 21 to generate smoke. The generated smoke is then inhaled by users through the inhaling beak 6.

The outer tube 1 is conical. The atomizing tube 23 is made of transparent materials. An elongated through hole 12 is disposed at a location of the outer tube 1 corresponding to the atomizing tube 23. During a working status of the electronic cigarette device, a remaining quantity status of tobacco liquid stored in the liquid storage I can be observed through the elongated through hole 12. An air passage exists between an outer wall of the atomizing tube 23 and an inner wall of the outer tube 1. Air enters the connector 22 from the elongated through hole 12 and through the air passage between the atomizing tube 23 and the outer tube 1 and the air passage between the connector 22 and the top of the PCB component 3.

A Universal Serial Bus (USB) port 8 used for charging the battery 4 is disposed at a bottom of the outer tube 1. A switch button 34 is provided and disposed on the PCB component 3. A hole 14 is disposed at a location of the outer tube 1 corresponding to the switch button 34.

Working processes of the electronic cigarette device in accordance with the present invention are described as follows.

In use, pressing the switch button 34 enables the heating element 21 to be electrically conducted via the printed circuit board 24 of the connector 22 and the electrode contact 32 of the PCB component 3. Since the air passage exists between the connector 22 and the top of the PCB component 3, air enters the connector 22 through the air inlet micro holes 25 installed and disposed on the printed circuit board 24 and is mixed with heated tobacco liquid by the heating element 21 to generate smoke. The generated smoke is then inhaled by users through the inhaling beak 6. Similar to working principles of sound suppressors, the electronic cigarette device in accordance with the present invention works silently and noiselessly because of the plurality of air inlet micro holes 25 installed and disposed on the printed circuit board 24. Besides, because of pressure differential of an inside of the electronic cigarette device and an outside of the electronic cigarette device, airflow fills toward the heating element 21 in the electronic cigarette device automatically, and the purpose of smoking smoothly and relaxingly for users can be achieved.

Compared with existing technology, the electronic cigarette device of the present invention utilizes the plurality of air inlet micro holes 25 installed and disposed on the printed circuit board 24 disposed at the bottom of the connector 22 to make the electronic cigarette device working silently and noiselessly. Airflow fills into the heating atomizing component 2 automatically so that the purpose of smoking smoothly and relaxingly for users can be achieved. Besides, the electronic cigarette device of the present invention uses the elastic electrode contact 32 to connect the battery 4 with the heating atomizing component 2. It has advantages of being easy to operate and high reliability.

Descriptions and applications of the present invention are intended to be illustrative, not intended to limit the scope of the present invention to the above described embodiment. Variations and modifications of the embodiment disclosed herein are possible, and for those of ordinary skilled in the field, alternative and equivalent various components of the embodiment are common senses and well known. Where any person skilled in this art should know that the present invention can be achieved in other forms, structures, arrangements, proportions, and with other components, materials, and parts, the changes or improvements are still covered within the inventive spirit of the present invention and the scope as defined in the following claims. Without departing from the spirit and scope of the present invention, people can make other modifications and changes of the embodiment disclosed herein.

What is claimed is:

1. An electronic cigarette device, comprising an outer tube, a heating atomizing component accommodated in the outer tube, a printed circuit board (PCB) component disposed at a bottom of the heating atomizing component and a battery electrically connecting to the PCB component, the heating atomizing component comprising a heating element, a connector electrically connecting to a bottom of the heating element, and an atomizing tube sheathedly installed outside the heating element and the connector, a top of the atomizing tube provided and disposed with a liquid filling cover and a detachable inhaling beak, a printed circuit board disposed at a bottom of the connector, a top of the PCB component provided and disposed with an electrode contact used for electrically connecting to the printed circuit board, a plurality of air inlet micro holes installed and disposed on the printed circuit board.

2. The electronic cigarette device as claimed in claim 1, wherein a liquid storage used for storing tobacco liquid is formed between the atomizing tube and the heating element, the heating atomizing component further comprises a liquid guiding twine used for delivering tobacco liquid to the heating element, the liquid guiding twine is located and disposed within the liquid storage.

3. The electronic cigarette device as claimed in claim 1, wherein a magnet attaches to the bottom of the connector.

4. The electronic cigarette device as claimed in claim 1, wherein the atomizing tube is made of transparent materials, an elongated through hole is disposed at a location of the outer tube corresponding to the atomizing tube.

5. The electronic cigarette device as claimed in claim 1, wherein a Universal Serial Bus (USB) port used for charging the battery is disposed at a bottom of the outer tube.

6. The electronic cigarette device as claimed in claim 1, wherein the electrode contact is an elastic electrode contact, a copper foil used for electrically conducting is provided and disposed on the printed circuit board.

7. The electronic cigarette device as claimed in claim 1, wherein the liquid filling cover is located at the top of the atomizing tube, a liquid filling hole and an exhaust hole are respectively disposed and installed at the liquid filling cover.

8. The electronic cigarette device as claimed in claim 1, wherein a switch button is provided and disposed on the PCB component, a hole is disposed at a location of the outer tube corresponding to the switch button.
